(19) United States
(12) Patent Application Publication
(10) Pub. No.: US 2026/0203053 A1
(43) Pub. Date: Jul. 16, 2026

(54) ADAPTIVE CONTEXT -AWARE PULL REQUEST SCORING AND PRIORITIZAITON ENGINE

(71) Applicant: Dell Products L.P., Round Rock, TX (US)

(72) Inventors: Robin Kedia, Singapore (SG); Antony Prabakaran Jayaveeran, Singapore (SG); Jeyaprakash Sethuram, Singapore (SG); Sneha Vijay, Singapore (SG)

(21) Appl. No.: 19/021,554

(22) Filed: Jan. 15, 2025

(51) Int. Cl. G06F 8/71; G06Q 10/0639

(52) U.S. Cl. CPC G06F 8/71; G06Q 10/06395

(57) ABSTRACT

A method to use a pull request scoring and prioritization (PRSP) engine to incorporate contextual awareness when reviewing a pull request (PR) of code from a developer is described. Using The PRSP engine addresses the contextual complexities of software development and frees up reviewer time by incorporating contextual awareness into a quality and scoring process. The PRSP engine uses a machine learning model to develop scores for the PR which are used to calculate a quality for the PR. Based on the quality, the PRSP engine after review by a PR reviewer either merges the code of the PR with a main code or sends the code back to the developer to be corrected.

### BACKGROUND

A pull request is a proposal to merge a set of changes in code made by developer on a project into a main code stored in a main repository. Prior to merging the set of changes in the code, the pull request must be reviewed to ensure the new code will not negatively affect the main code (e.g., cause errors). The review may be done by one or more fellow developers (e.g., senior developers) acting as reviewers. Once approved by the reviewers the set of changes in the code are merged in the main code in the main repository. The process can be repeated with other pull requests for other changes until all developers on the project have had their set of changes merged into the main code. The traditional approach of reviewing pull requests is primarily manual, time consuming, and resource intensive.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1.1 shows a diagram of a system including a pull request scoring and prioritization engine in accordance with one or more embodiments disclosed herein.

FIG. 1.2 shows a diagram of a data ingestion module shown in FIG. 1.1 in accordance with one or more embodiments disclosed herein.

FIG. 1.3 shows a diagram of a contextual analysis module shown in FIG. 1.1 in accordance with one or more embodiments disclosed herein.

FIG. 1.4 shows a diagram of a quality and scoring module shown in FIG. 1.1 in accordance with one or more embodiments disclosed herein.

FIG. 2.1-2.2 show flowcharts for a method for reviewing a pull request (PR) in accordance one or more embodiments disclosed herein.

FIG. 3 shows a table of predetermined rules in accordance with one or more embodiments disclosed herein.

FIG. 4 shows a diagram of a computing device in accordance with one or more embodiments disclosed herein.

### DETAILED DESCRIPTION

In traditional code review processes, pull requests are often handled based on simplistic criteria such as bug fixes, build success or arbitrary labels. However, this approach neglects the contextual complexities of software development, leading to inefficient use of reviewer resources and delayed feedback leading to productivity loss. When performing a PR check, the reviewer begins by reviewing the code changes for readability, feature/bug fix, adherence to the project's guide which include a continuous integration build, different kind of scans, unit/regression tests etc. These checks ensure the changes meet the outlined requirements before merge. However, there is no way to prioritize the PR and get it reviewed/approved fast when the reviewer list is limited.

For at least the reasons discussed above, a fundamentally different approach/framework is needed to improve review of PRs.

Embodiments disclosed herein relate to a pull request scoring and prioritization engine that aims to address the above limitations and free up reviewer time by incorporating contextual awareness into a quality and scoring process of PRs in a project. The PR scoring and prioritization engine grades the pull request using a quality level system (e.g., green, yellow, and red quality) visible to the reviewer. The pull request scoring and prioritization engine may also identify the correct reviewer for a particular pull request and determine an order for concurrent PR requests to be merged with a main code of the project. The PR scoring and prioritization engine allows for the ability to adapt to the dynamic context of software development including factors such as code complexity, temporal context, collaborative dynamics, a PR dependency analyser, and cumulative assessment. Reviewing the code complexity allows a determination for the amount of review effort required. The temporal context considers the timing of PR submissions for peak development hours or critical deadlines. The collaborative dynamics accesses interactions between developers and reviewers to optimize feedback loops. The PR dependency analyser learns the inter component dependencies of PRs to provide quick feedback to reviewers and developers to address integration failures. The cumulative assessment provides a summarized score that reflects the collective evaluation of the PR.

The following describes various embodiments disclosed herein.

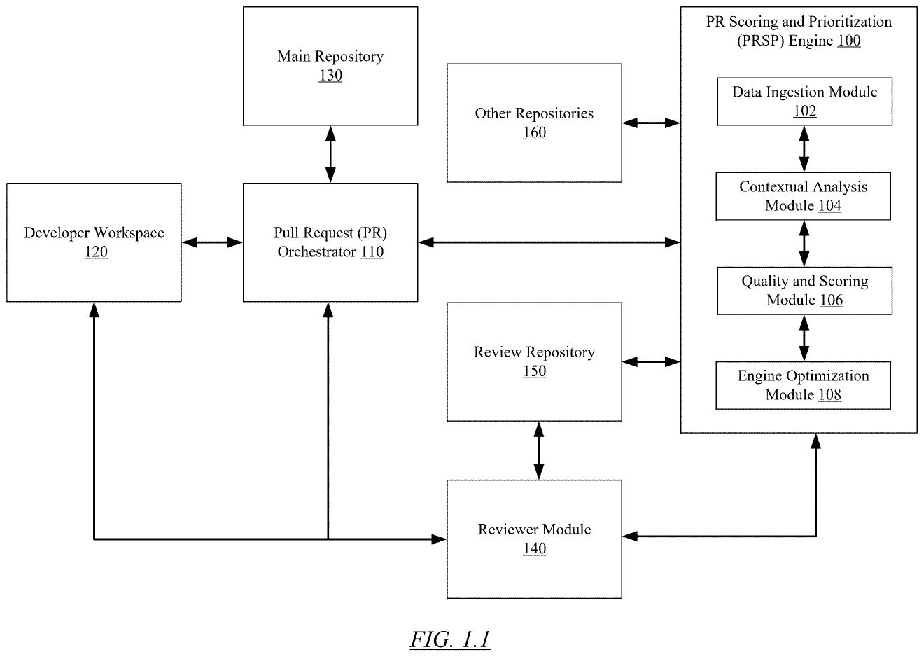

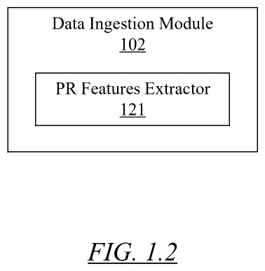

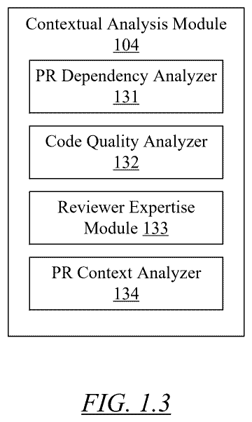

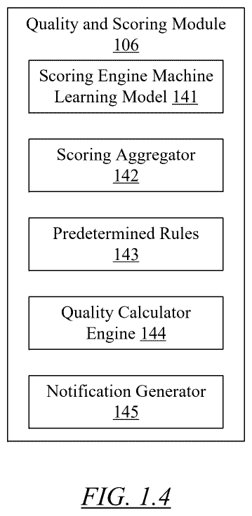

FIG. 1.1 shows a diagram of a system including a pull request scoring and prioritization engine in accordance with one or more embodiments disclosed herein. The system includes a pull request scoring and prioritization (PRSP) engine (100), a pull request (PR) orchestrator (110), a developer workspace (120), a main repository (130), a reviewer module (140), a review repository (150), and other repositories (160). The system is used to review PRs for a project. The project may be any coding project especially a project with multiple developers working on separate code to be merged into a main code of the project. The PRSP engine is connected to the PR orchestrator (110) to receive PRs. The PRSP engine (100) is connected to the review repository (150) and the other repositories (160) to receive information on previous reviews, previous PRs, and other information. The PRSP engine (100) is connected to the reviewer module (140) to transmit and receive PRs. The reviewer module (140) is connected to the PR orchestrator (110) and developer workspace (120) to transmit PRs. The reviewer module (140) is also connected to the review repository (150) to store information on previous reviews. The PR orchestrator (110) is connected to the developer workspace (120) to receive code that is formed into a PR for approval to be merged with a main code. The PR orchestrator (110) is also connected to the main repository (130) to merge the code from the PR into the main code.

The system may include additional, fewer, and/or different components without departing from the scope of the embodiments disclosed herein. Each component may be operably/operatively connected to any of the other components via any combination of wired and/or wireless connections (including connections to local area networks, wireless networks, and wide area networks). For example, the components shown in FIG. 1.1 may be connected via a network fabric (not shown). A network fabric refers to the interconnected topology and structure of network elements, e.g., switches, routers, and links, which work together to provide data transmission within between the components. The network fabric may be implemented using a spine-leaf topology, where every leaf switch connects to each spine switch. Those skilled in the art will appreciate that any other type of network (or network topology) may be used without departing from the invention.

Each of these components shown in FIG. 1.1 is described below.

The PRSP engine (100) includes a data ingestion module (102), a contextual analysis module (104), a quality and scoring module (106), and an engine optimization module (108). The data ingestion module (102) extracts features from the PRs and is further described in FIG. 1.2. The contextual analysis module (104) determines context, code quality, dependency, and which PR reviewer(s) to use based on the features and is further described in FIG. 1.3. The quality and scoring module (106) determines scores for the PRs using the features, context and PR reviewers'expertise and forms a quality for the PRs using the scores. The quality and scoring module (106) is further described in FIG. 1.4. The engine optimization module (108) improves the functioning of the PRSP engine based on the review of previous PRs. The engine optimization module may continuously monitor performance of the PRSP engine (100). Parameters of the PRSP engine (100) may be adjusted as needed to ensure optimal scalability and accuracy. The system may include additional, fewer, and/or different components without departing from the invention.

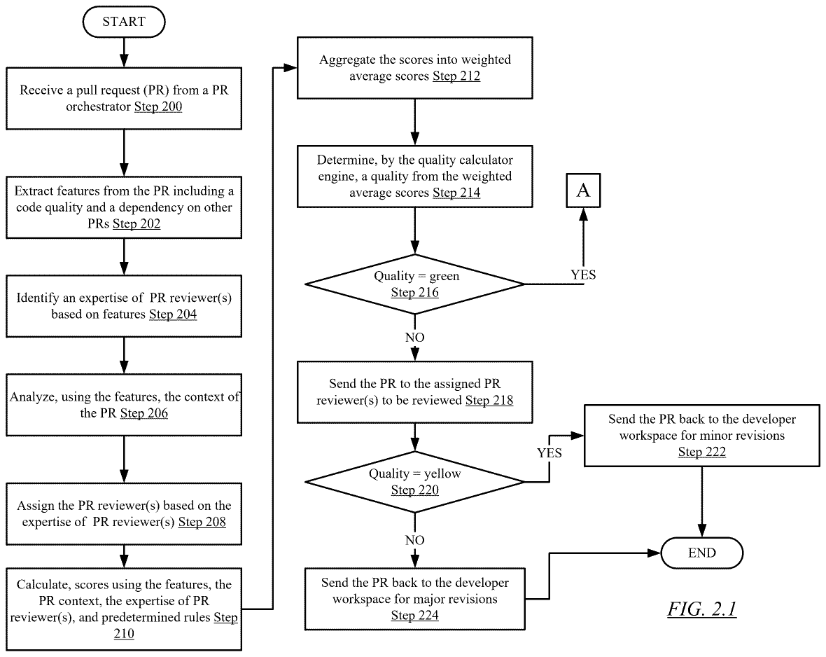

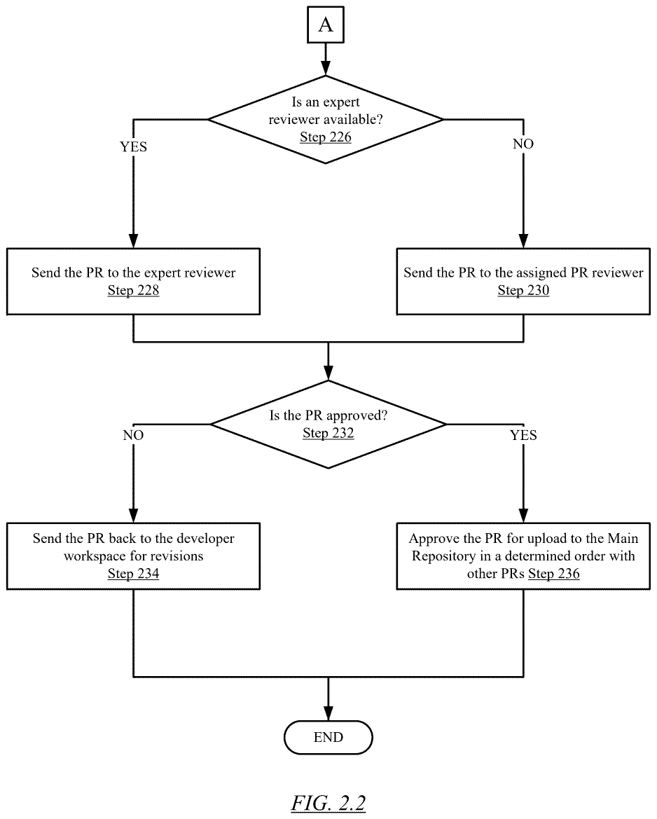

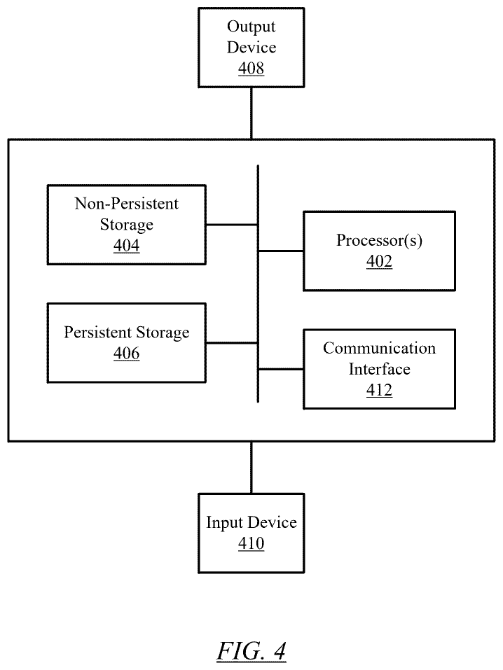

In one or more embodiments of the invention, the PRSP engine (100) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the PRSP engine (100) described throughout this application and/or all, or a portion thereof, of the methods illustrated in FIG. 2.1-2.2.

In one or more embodiments of the invention, the PRSP engine (100) is implemented as a logical device(s) (e.g., a virtual machine). Each logical device may utilize the computing resources of any number of computing devices and thereby provide the functionality of the PRSP engine (100) described throughout this application and/or all, or a portion thereof, of the methods illustrated in FIG. 2.1-2.2.

The PR orchestrator (110) is configured to receive the PRs from the developer workspace (120). The PR orchestrator (110) triggers the PRSP engine (100) to assign a quality to a PR by transmitting the PR to the PRSP engine (100). After a PR has been reviewed, the PR may return to the PR orchestrator (110) to be merged with the main code in the main repository (130) as discussed further with the method of FIG. 2.1-2.2. If the PRSP engine (100) determines an order that PRs should be merged with the main code as discussed further in the method of FIG. 2.1-2.2, the PR orchestrator (110) executes the merger of the PRs in the order received from the PRSP engine (100).

In one or more embodiments of the invention, the PR orchestrator (110) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the PR orchestrator (110) described throughout this application and/or all, or a portion thereof, of the methods illustrated in FIG. 2.1-2.2.

In one or more embodiments of the invention, the PR orchestrator (110) is implemented as a logical device(s). Each logical device may utilize the computing resources of any number of computing devices and thereby provide the functionality of the PR orchestrator (110) described throughout this application and/or all, or a portion thereof, of the methods illustrated in FIG. 2.1-2.2.

The developer workspace (120) is a system that includes a user interface through which code is modified and/or developed by a developer of the project. While not shown in FIG. 1.1, in some embodiments, multiple developer workspaces are present in the system and each connected to the PR orchestrator (110) and the reviewer module (140). For example, each developer on the project may have a separate developer workspace. The developer works on code that will be merged into the main code of the project. Once the developer completes/finishes modifying the code, the developer forms a PR containing the code to be merged into the main code.

In one or more embodiments of the invention, the developer workspace (120) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the developer workspace (120) described throughout this application and/or all, or a portion thereof, of the methods illustrated in FIG. 2.1-2.2.

In one or more embodiments of the invention, the developer workspace (120) is implemented as a logical device(s). Each logical device may utilize the computing resources of any number of computing devices and thereby provide the functionality of the developer workspace (120) described throughout this application and/or all, or a portion thereof, of the methods illustrated in FIG. 2.1-2.2.

The main repository (130) contains the main code of the project. Changes to the main code via PRs from developers are merged into the main code in the main repository (130). The main code is held in the main repository (130) to keep the main code separate from potential changes until the changes have been reviewed in a PR. The changes are merged in the main repository (130) by the PR orchestrator (110).

In one or more embodiments of the invention, the main repository (130) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the main repository (130) described throughout this application and/or all, or a portion thereof, of the methods illustrated in FIG. 2.1-2.2.

In one or more embodiments of the invention, the main repository (130) is implemented as a logical device(s). Each logical device may utilize the computing resources of any number of computing devices and thereby provide the functionality of the main repository (130) described throughout this application and/or all, or a portion thereof, of the methods illustrated in FIG. 2.1-2.2.

The reviewer module (140) is a system that includes a user interface through which reviewers are able to review PRs. While not shown in FIG. 1.1, in some embodiments, multiple reviewer modules are present in the system each connected to the PR orchestrator (110) and the reviewer module (140). For example, each PR reviewer (e.g., assigned PR reviewer and expert reviewer) on the project may have a separate reviewer module. The PR reviewer reviews the PR after the PRSP engine creates a quality for the PR.

In one or more embodiments of the invention, the reviewer module (140) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the reviewer module (140) described throughout this application and/or all, or a portion thereof, of the methods illustrated in FIG. 2.1-2.2.

In one or more embodiments of the invention, the reviewer module (140) is implemented as a logical device(s). Each logical device may utilize the computing resources of any number of computing devices and thereby provide the functionality of the reviewer module (140) described throughout this application and/or all, or a portion thereof, of the methods illustrated in FIG. 2.1-2.2.

The review repository (150) stores information on previous PRs including information on PR reviewers. In one or more embodiments of the invention, the review repository (150) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the review repository (150) described throughout this application and/or all, or a portion thereof, of the methods illustrated in FIG. 2.1-2.2.

In one or more embodiments of the invention, the review repository (150) is implemented as a logical device(s). Each logical device may utilize the computing resources of any number of computing devices and thereby provide the functionality of the review repository (150) described throughout this application and/or all, or a portion thereof, of the methods illustrated in FIG. 2.1-2.2.

The other repositories (160) stores information on code quality needed for the project, information on the project, and/or policies associated with the project custom and industry rule configurations. In one or more embodiments of the invention, the other repositories (160) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the other repositories (160) described throughout this application and/or all, or a portion thereof, of the methods illustrated in FIG. 2.1-2.2.

In one or more embodiments of the invention, the other repositories (160) are implemented as a logical device(s). Each logical device may utilize the computing resources of any number of computing devices and thereby provide the functionality of the other repositories (160) described throughout this application and/or all, or a portion thereof, of the methods illustrated in FIG. 2.1-2.2.

FIG. 1.2 shows a diagram of the data ingestion module (102) shown in FIG. 1.1 in accordance with one or more embodiments disclosed herein. The data ingestion module (102) includes a PR feature extractor (121). The PR feature extractor (121) is configured to extract features from the PR. The PR feature extractor (121) also collects data on code metrics of the project, and collaborative dynamics of the project from the other repositories (160) and data on current PR reviewer expertise from the review repository (150).

FIG. 1.3 shows a diagram of the contextual analysis module (104) shown in FIG. 1.1 in accordance with one or more embodiments disclosed herein. The contextual analysis module (104) analyzes the data collected by the data ingestion module (102). In some embodiments, machine learning models are employed to analyze the data. The contextual analysis module (104) includes a PR dependency analyzer (131), a code quality analyzer (132), a reviewer expertise module (133), and a PR context analyzer (134). The PR dependency analyzer (131) analyzes the data to determine if the PR being reviewed is dependent on other PRs in the project or if the other PRs are dependent on the PR. The code quality analyzer (132) analyzes a quality of the code contained in the PR for use in the quality and scoring module (106). The reviewer expertise module (133) determines the expertise needed for a PR reviewer to review the PR. The PR context analyzer (134) determines the context of the PR using the features extracted by the data ingestion module (102) as described in FIG. 2.1-2.2.

FIG. 1.4 shows a diagram of the quality and scoring module (106) shown in FIG. 1.1 in accordance with one or more embodiments disclosed herein. The quality and scoring module (106) generates a quality from a comprehensive scoring model for a PR using the context, the quality of the code, the reviewer expertise from the contextual analysis module (104) and the features from the data ingestion module (102). The quality and scoring module (106) includes a scoring engine machine learning model (141), a scoring aggregator (142), predetermined rules (143), a quality calculator engine (144), and a notification generator (145). The scoring engine machine learning model (141) calculates scores for the predetermined rules (143) as described in FIG. 2.1-2.2. The scoring aggregator (142) aggregates the scores into weighted scores that can be compared across the predetermined rules (143). The quality calculator engine (144) calculates a quality for the PR using the weighted scores. The predetermined rules (143) are stored in the quality and scoring module (106) and can be selected by the PR reviewers for the project. The notification generator (145)

Turning now to FIG. 2.1, FIG. 2.1 shows a flow diagram describing a method for reviewing a PR in accordance with one or more embodiments disclosed herein. The method of FIG. 2.1 may be performed by, for example, the PRSP engine (e.g., 100, FIG. 1.1) and the PR orchestrator (e.g., 110, FIG. 1.1). Other components of the system of FIG. 1.1 may perform all, or a portion, of the method of FIG. 2.1 without departing from the disclosure.

While the various steps in the flowcharts are presented and described sequentially, one of ordinary skill in the relevant art will appreciate that some or all of the steps may be executed in different orders, may be combined, or omitted, and some or all steps may be executed in parallel.

In Step 200, the PRSP engine receives a PR from the PR orchestrator. The PR may represent changes to a main code of a project stored in a main code repository (e.g., 130, FIG. 1.1) requiring review prior to being merged with the main code. The PR may be formed by a developer on a developer workspace (e.g., 120, FIG. 1.1). The PR includes the code created by the developer to be incorporated into the main code and a request to review the code to authorize the codes merger into the main code. The PR is sent to the PR orchestrator prior to being received at the PRSP engine. The PR orchestrator transmits the PR to the PRSP engine triggering the PRSP engine to begin reviewing the PR.

In Step 202, the PRSP engine extracts features from the PR. The features may include a code quality and a dependency on other PRs. The features may further include code changes, commit messages included in the code, the identity of the developer who developed the code and other related features. The features may be extracted from the PR using a data ingestion module (e.g., 102, FIG. 1.1) of the PRSP engine as discussed in FIG. 1.2.

In Step 204, the PRSP engine identifies an expertise of PR reviewer(s) needed for the PR based on the features. A contextual module (e.g., 104, FIG. 1.1) may be used to identify the expertise of PR reviewer(s). Previous reviews by PR reviewers may be analyzed from a review repository (e.g., 150, FIG. 1.1). The previous reviews may assist in identifying the expertise of PR reviewer(s) needed. The expertise of PR reviewer(s) is used by the PRSP engine to later identify PR reviewers to review the PR and to create a quality for the PR as described below.

In Step 206, the PRSP engine analyzes the context of the PR using the features. The contextual module may analyze the context of the PR. The context may be contained in the features. To analyze the context of the PR, information on the PR and the project not included in the PR may be received from other repositories (e.g., 160, FIG. 1.1). The context includes the velocity of the code and the project (i.e., timeframe needed for completion) and determines any dependency relationship the PR has with other PRs of the project. For example, the context of the PR might determine that the project overall or the code contained in the PR has a velocity needing expedited review due to an upcoming deadline.

The dependency of the PR to other PRs allows for the PRSP to determine an order of merger into the main code between the PR and other concurrent PRs. For example, if the PR contains code that is dependent on a portion of second code that is part of a second PR, the second PR should be merged first into the main code followed by the PR. The dependency of the PR is stored in the PRSP engine as the method continues.

In Step 208, the PRSP engine assigns the PR reviewer(s) based on the expertise of the PR reviewer(s). Based on the expertise of the PR reviewer(s) needed, the PRSP engine assigns at least one PR reviewer based on available PR reviewers(s) that have the needed expertise. The PRSP engine determines if the available PR reviewer(s) with the reviewer repository.

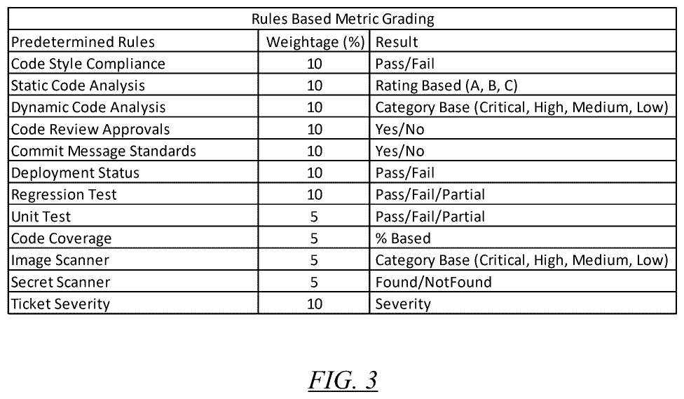

In Step 210, the PRSP engine calculates scores for the PR using the features, the PR context, the expertise of PR reviewer(s), and predetermined rules. Prior to calculating the scores, the PRSP determines a code quality based on metrics including complexity, readability, and test coverage. The code quality is used with the predetermined rules to form scores. The contextual module may analyze the code quality of the PR. The scores may be calculated with a quality and scoring module (e.g., 106, FIG. 1.1). A machine learning model is used to calculate the scores with the features, the PR context, the expertise of PR reviewer(s) as inputs and the scores for each predetermined rule as the output of the machine learning model. The score may be a numerical value, a value of pass/fail, or a rating. Results of the score are discussed further in FIG. 3.

For example, a predetermined rule may be code style compliance. The machine learning model uses the inputs of for the features, the PR context, the expertise of PR reviewer(s), and the PR as inputs to generate a score for the predetermined rule of code compliance. The predetermined rule specifies a score can either be pass or fail. The machine learning model determines that for the predetermined rule of code compliance the score is pass. The predetermined rules may be predetermined rules (e.g., 143, FIG. 1.4) further described in FIG. 3. The machine learning model may be a scoring engine machine learning model (e.g., 141, FIG. 1.4).

In Step 212, the PRSP engine aggregates the scores into weighted average scores. The aggregation of the scores may be completed by the quality and scoring module. The machine learning model of Step 210 may calculate a plurality of scores for each predetermined rule. Each predetermined rule has an associated weightage for the rule. For example, the code style compliance has a weightage of 10%. Each score for each predetermined rule is converted to a numerical value and weighted based on the assigned weightage. The plurality of scores is aggregated into a weighted average score for each predetermined rule. Exemplary weightage for the predetermined rules is discussed in FIG. 3.

In Step 214, the PRSP engine determines a quality from the weighted average scores. The quality may be determined by the quality and scoring module. The quality is calculated by adding the weighted average scores for each predetermined rule to calculate the quality. The quality may be, for example, three separate quality levels set by the PRSP engine or the PR reviewers. For example, the quality may be a value between 0-100. A first quality level may be from 90-100 and be the highest level. A second quality level may be from 70-90 and be the middle level. A third quality level may be from 0-69 and be the lowest level. The quality determined by the PRSP engine is used to determine how to dispose of the PR in the steps below. The technology is not limited to the three quality levels listed above. The technology may be implemented using greater or fewer quality levels without departing from the technology. Further, the technology is not limited to the value ranges for the quality noted above.

In Step 216, the PRSP engine makes a first determination as to whether the quality of the PR is at a first quality level (i.e., green) of three quality levels. A green quality level indicates a high quality PR (e.g., greater than 90) which is ready for merging with the main code. The PR receiving a green quality level indicates that the code meets all necessary criteria and standards. Accordingly, in one or more embodiments, if the result of the first determination is YES, the method proceeds to Step 226. If the result of the first determination is NO, the method alternatively proceeds to Step 218.

In Step 218, as a result of the first determination in Step 216 being NO, the PRSP engine sends the PR to the assigned PR reviewer(s) to be reviewed. The assigned PR reviewer(s) may be informed that a PR is pending their review via a notification generator (e.g., 145, FIG. 1.4).

In Step 220, the PRSP engine makes a second determination as to whether the quality of the PR is at a second quality level (i.e., yellow) of the three quality levels. A yellow quality level indicates improvements are needed in the code. The PR receiving a yellow quality level indicates that the code needs changes prior to merging with the main code. Accordingly, in one or more embodiments, if the result of the second determination is YES, the method proceeds to Step 222. If the result of the second determination is NO, the method alternatively proceeds to Step 224.

In Step 222, as a result of the second determination in Step 220 being YES (i.e., the PR has the yellow quality level), the PRSP engine sends the PR back to the developer workspace for minor revisions. Before sending the PR back to the developer, the assigned PR reviewer(s) review the PR and the quality and approve the PR to be sent back to the developer workspace. The PR reviewer may make comments on the PR for the developer. When the PR is sent back to the developer workspace, the notification generator, notifies the developer the PR has been returned to the developer workspace and requires minor revisions. After Step 222 is completed, the method ends.

In Step 224, as a result of the second determination in the Step 220 being NO, the PRSP engine sends the PR back to the developer workspace for major revisions. Because the result of the second determination was NO, the quality of the PR is at a third quality level (i.e., red) of the three quality levels. A red quality level indicates significant improvements are needed in the code. The PR receiving a red quality level indicates that the code does not meet the required standards and needs substantial revisions. Before sending the PR back to the developer, the assigned PR reviewer(s) review the PR and the quality and approve the PR to be sent back to the developer workspace. The PR reviewer may make comments on the PR for the developer. When the PR is sent back to the developer workspace, the notification generator, notifies the developer the PR has been returned to the developer workspace and requires major revisions. After Step 224 is completed, the method ends.

Turning to FIG. 2.2, in Step 226, as a result of the first determination in Step 216 being YES, the PRSP engine makes a third determination as to whether an expert reviewer is available to approve the PR. Because the quality of the PR is at the green quality level, the PR can be reviewed by the expert reviewer of the project. The expert reviewer may expedite merging the code of the PR with the main code. In some embodiments, the PRSP engine checks the reviewer module to determine if the expert reviewer is available. Accordingly, in one or more embodiments, if the result of the third determination is YES, the method proceeds to Step 228. If the result of the third determination is NO, the method alternatively proceeds to Step 230.

In Step 228, as a result of the third determination in the Step 226 being YES, the PRSP engine sends the PR to the expert reviewer. The expert reviewer may be notified that the PR is on the reviewer module for review by the notification generator. The expert reviewer then reviews the PR and the quality. The expert reviewer either approves the PR to be merged with the main code or rejects the PR for merger with the main code. In some embodiments, if the PR is rejected, the expert reviewer may leave comments. The method then proceeds to Step 232.

In Step 230, as a result of the third determination in the Step 226 being NO, the PRSP engine sends the PR to the assigned PR reviewer(s). The assigned PR reviewer(s) may be notified that the PR is on the reviewer module for review by the notification generator. The assigned PR reviewer(s) then reviews the PR and the quality. The assigned PR reviewer(s) either approves the PR to be merged with the main code or rejects the PR for merger with the main code. In some embodiments, if the PR is rejected, the assigned PR reviewer(s) may leave comments. The method then proceeds to Step 232.

In Step 232, the PRSP engine makes a fourth determination as to whether the PR is approved to be merged with the main code. The PRSP engine determines if the expert reviewer/assigned PR reviewer(s) approved the PR. Accordingly, in one or more embodiments, if the result of the fourth determination is NO, the method proceeds to Step 234. If the result of the fourth determination is YES, the method alternatively proceeds to Step 236.

In Step 234, as a result of the fourth determination in the Step 232 being NO, the PRSP engine sends the PR back to the developer workspace for revisions. If the expert reviewer or assigned PR reviewer(s) left any comments on the PR, the comments are sent to the developer workspace with the PR. After Step 234 is completed, the method ends.

In Step 236, as a result of the fourth determination in the Step 232 being YES, the PRSP engine sends the PR for upload to the main repository via the PR orchestrator. The PR is merged with the main code in a determined order with other PRs based on dependences between the PRs as described in Step 206. For example, if the PR is determined to be dependent on a second PR that is being reviewed while the PR is being reviewed, the PR will be held in the PR orchestrator until the second PR is merged with the main code due to the dependency. After Step 236 is completed, the method ends.

If the PR is sent back to the developer workspace for revisions, after revisions are made by the developer, a new PR can be made by the developer. The new PR is sent to the PR orchestrator and the method may repeat to determine if the code is ready to be merged with the main code.

After the method is completed, data from the PR and the quality is stored in the other repositories. Data on the expert reviewer or assigned PR reviewer(s) review of the PR is stored in the review repository. An engine optimization module (e.g., 108, FIG. 1.1) uses the data stored on the other repositories and the review repository to refine the PRSP engine.

FIG. 3 shows a table of predetermined rules in accordance with one or more embodiments disclosed herein. The table includes the predetermined rules, a weightage for each predetermined rules, and results available for each predetermined rule. In some embodiments, as shown in FIG. 3, the predetermined rules include code style compliance, static code analysis, dynamic code analysis, code review approvals, commit message standards, deployment status, regression test, unit test, code coverage, image scanner, secret scanner, and ticket severity. The code style compliance is an automated check for programmatic and stylistic errors (i.e., linting). The static code analysis is a software testing that examines the code without running the code. The dynamic code analysis is a software testing that examines the code while running the code. The code review approvals are inferences made by the machine learning model if the code would be approved by a reviewer with the required expertise. The commit message standards are a review of the commit message associated with the code of the PR. The deployment status is a review of the status of the portion of code in the project the code of the PR is replacing. The regression test is a testing method that re-runs existing test cases on the code of the PR to ensure previous working functionalities of the code have not been broken by the code changes. The unit test is used to test the smallest functional unit of the code. The code coverage is a metric that measures a percentage of the code that is executed during a test. The image scanner is a test that finds security vulnerabilities. The secret scanner identifies information in the code that should be secret and not be included. The ticket severity includes the impact of the code on the project.

The weightage indicates a percentage of the weighted score for each predetermined rule should have towards the quality. Together with the result for each rule discussed below, the weightage converts the result into a numerical value that can be combined into a single quality. In FIG. 3, the weightage varies from 5% to 10% across the predetermined rules such that the summation of all the weightages for all the predetermined rules equals 100%. In other embodiments, the weightage may vary dependent on the amount of predetermined rules and the relative importance of the predetermined rules.

The results indicate the initial output of the machine learning model for each predetermined rule. The results may contain pass/fail, rating based (A, B, C), category base (Critical, High, Medium, Low), yes/no, pass/fail/partial, percentage base, found/not found, and severity. The results can be converted into numerical values to determine the scores. For example, pass, yes, and not found may equal one and fail, no, and found can equal zero. Percentage and severity can be described as a number between 0 and 1 include both numbers. Partial can be equal 0.5, A can equal 1, B can equal 0.066, and C can equal 0.33. In other embodiments, different values can be assigned for the results. As discussed with the weightage, the values allow for the results to be compiled into a single quality for the code of the PR.

As discussed above, embodiments of the disclosure may be implemented using computing devices. FIG. 4 shows a diagram of a computing device in accordance with one or more embodiments disclosed herein. The computing device may include one or more computer processor(s) (402), non-persistent storage (404) (e.g., volatile memory, such as RAM, cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the disclosure, the processor(s) (402) may be an integrated circuit for processing instructions. For example, the computer processor(s) may be one or more cores or micro-cores of a processor. The computing device may also include one or more input devices (410), such as a touchscreen, keyboard, mouse, microphone, touchpad, electronic pen, or any other type of input device. Further, the communication interface (412) may include an integrated circuit for connecting the computing device to a network (not shown) (e.g., a local area network (LAN), a wide area network (WAN) such as the Internet, mobile network, or any other type of network) and/or to another device, such as another computing device.

In one embodiment of the disclosure, the computing device may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to enable the computer processor to perform one or more embodiments described herein.

The problems discussed above should be understood as being examples of problems solved by embodiments of the disclosure disclosed herein and the disclosure should not be limited only to solving the same/similar problems. The disclosure is broadly applicable to address a range of problems beyond those discussed herein.

Specific embodiments are described with reference to the accompanying figures. In the above description, numerous details are set forth as examples. It will be understood by those skilled in the art, that one or more embodiments of the present disclosure may be practiced without these specific details, and that numerous variations or modifications may be possible without departing from the scope. Certain details known to those of ordinary skill in the art are omitted to avoid obscuring the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase connect, operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered a connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While the disclosure has been described above with respect to a limited number of embodiments, those skilled in the art, having the benefit of this disclosure, will appreciate that other embodiments can be devised which do not depart from the scope as disclosed herein. Accordingly, the scope of the disclosure should be limited only by the attached claims.

What is claimed is:

1. A method for reviewing a pull request (PR) for a project, comprising:
receiving, at a PR scoring and prioritization (PRSP) engine, a first PR, wherein:
the first PR comprises a first code and is a request by a developer to have the first code incorporated into a main code for the project, and
the first PR is stored on a PR orchestrator after being received from a developer workspace;
extracting first features from the first PR;
after extracting the first features from the PR, identifying a required expertise of PR reviewers needed to review the first PR using the first features;
analyzing a first context of the first PR, wherein the first context is contained in the first features and determines any dependency relationship the first PR has with other PRs of the project;
calculating, by a quality and scoring module of the PRSP engine comprising a scoring engine machine learning model, first weighted average scores for predetermined rules of the first PR using the first features, the first context, and the required expertise of the PR reviewers, wherein the predetermined rules determine code quality;
determining, by a quality calculator engine of the PRSP, a first quality based on the first weighted average scores for the predetermined rules;
after determining the first quality, making a first determination that the first quality is at a first quality level, wherein the first quality level is one of a plurality of quality levels;
after making the first determination:
making a second determination that an expert reviewer is available to review the first PR;
transmitting the first PR and first quality to the expert reviewer in response to the second determination, wherein the expert reviewer approves the first PR to be uploaded to a main repository; and
after the expert reviewer approves the first PR, uploading the first code in the first PR to the main repository via the PR orchestrator to be merged with the main code, wherein uploading is performed in a first order with the other PRs using the dependency relationship contained in the first context.

2. The method of claim 1, further comprising:
receiving, at the PRSP engine, a second PR, wherein:
the second PR comprises a second code and is a second request by the developer to have the second code incorporated into the main code for the project, and
the second PR is stored on the PR orchestrator after being received from the developer workspace;
extracting second features from the second PR;
after extracting the second features from the second PR, identifying a second required expertise of the PR reviewers needed to review the second PR using the second features;
analyzing a second context of the second PR, wherein the second context is contained in the second features and determines any second dependency relationship the second PR has with the other PRs of the project;
in response to the second required expertise of the PR reviewers, assigning at least one assigned PR reviewer using the second features;
calculating, by the quality and scoring module of the PRSP engine comprising a scoring engine machine learning model, a second weighted average score for the predetermined rules of the second PR using the second features, the second context, and the second required expertise of the PR reviewers;
determining, by the quality calculator engine of the PRSP, a second quality based on the second weighted average score for the predetermined rules;
after determining the second quality, making a third determination that the second quality is at the first quality level of the plurality of quality levels;
after making the third determination:
making a fourth determination that the expert reviewer is not available to review the second PR;
transmitting the second PR and the second quality to the at least one assigned PR reviewer in response to the fourth determination, wherein the at least one assigned PR reviewer approves the second PR to be uploaded to the main repository; and
after the at least one assigned PR reviewer approves the second PR, uploading the second code in the second PR to the main repository via the PR orchestrator to be merged with the main code, wherein uploading is performed in a second order with the other PRs using the second dependency relationship contained in the second context.

3. The method of claim 1, further comprising:
receiving, at the PRSP engine, a second PR, wherein:
the second PR comprises a second code and is a second request by the developer to have the second code incorporated into the main code for the project, and
the second PR is stored on the PR orchestrator after being received from the developer workspace, and
extracting second features from the second PR;
after extracting the second features from the second PR, identifying a second required expertise of the PR reviewers needed to review the second PR using the second features;
analyzing a second context of the second PR, wherein the second context is contained in the second features and determines any second dependency relationship the second PR has with the other PRs of the project;
in response to the second required expertise of the PR reviewers, assigning at least one assigned PR reviewer using the second features;
calculating, by the quality and scoring module of the PRSP engine comprising a scoring engine machine learning model, a second weighted average score for the predetermined rules of the second PR using the second features, the second context, and the second required expertise of the PR reviewers;
determining, by the quality calculator engine of the PRSP, a second quality based on the second weighted average score for the predetermined rules;
after determining the second quality, making a third determination that the second quality is not at the first quality level of the plurality of quality levels;
after making the third determination:
making a fourth determination that the second quality is at a second quality level of the plurality of quality levels;
transmitting, in response to the fourth determination, the second PR to the assigned PR reviewer, wherein the at least one assigned PR reviewer approves sending the second PR to be sent back to the developer workspace for minor revisions; and
after the at least one assigned PR reviewer approves sending the second PR to the developer workspace, transmitting the second PR to the developer workspace for minor revisions.

4. The method of claim 1, further comprising:
receiving, at the PRSP engine, a second PR, wherein:
the second PR comprises a second code and is a second request by the developer to have the second code incorporated into the main code for the project, and
the second PR is stored on the PR orchestrator after being received from the developer workspace;
extracting second features from the second PR;
after extracting the second features from the second PR, identifying a second required expertise of the PR reviewers needed to review the second PR using the second features;
analyzing a second context of the second PR, wherein the second context is contained in the second features and determines any second dependency relationship the second PR has with the other PRs of the project;
in response to the second required expertise of the PR reviewers, assigning at least one assigned PR reviewer using the second features;
calculating, by the quality and scoring module of the PRSP engine comprising a scoring engine machine learning model, a second weighted average score for the predetermined rules of the second PR using the second features, the second context, and the second required expertise of the PR reviewers;
determining, by the quality calculator engine of the PRSP, a second quality based on the second weighted average score for the predetermined rules;
after determining the second quality, making a third determination that the second quality is not at the first quality level of the plurality of quality levels;
after making the third determination:
making a fourth determination that the second quality is at a third quality level of the plurality of quality levels;
transmitting, in response to the fourth determination, the second PR to the assigned PR reviewer, wherein the at least one assigned PR reviewer approves sending the second PR to be sent back to the developer workspace for major revisions; and
after the at least one assigned PR reviewer approves sending the second PR to the developer workspace, transmitting the second PR to the developer workspace for major revisions.

5. The method of claim 1, wherein extracting the first features from the first PR comprises:
extracting code changes, commit messages, the first context, and developer information; and
analyzing, by a code quality analyzer, the first PR using metrics comprising complexity, readability, and test coverage.

6. The method of claim 1, wherein calculating the first weighted average scores for the predetermined rules comprises:
calculating first scores for the predetermined rules as an output and using the first features, the predetermined rules, and the required expertise of the PR reviewers as inputs for the scoring engine machine learning model; and
aggregating, by a scoring aggregator, the first scores into the first weighted average scores.

7. The method of claim 6, wherein the predetermined rules comprise code style compliance, static code analysis, dynamic code analysis, code review approvals, commit message standards, deployment status, regression test, unit test, code coverage, and ticket severity.

8. The method of claim 1, wherein the first PR is determined to be dependent on a second PR based on the first context, and after the first PR and the second PR are approved to be merged with the main code, the second PR is uploaded into the main repository before the first PR from the PR orchestrator.

9. A non-transitory computer readable medium (CRM) comprising computer readable program code, which when executed by a computer processor enables the computer processor to perform a method for reviewing a pull request (PR) for a project, the method comprising:
receiving, at a PR scoring and prioritization (PRSP) engine, a first PR, wherein:
the first PR comprises a first code and is a request by a developer to have the first code incorporated into a main code for the project, and
the first PR is stored on a PR orchestrator after being received from a developer workspace;
extracting first features from the first PR;
after extracting the first features from the PR, identifying a required expertise of PR reviewers needed to review the first PR using the first features;
analyzing a first context of the first PR, wherein the first context is contained in the first features and determines any dependency relationship the first PR has with other PRs of the project;
calculating, by a quality and scoring module of the PRSP engine comprising a scoring engine machine learning model, a first weighted average score for predetermined rules of the first PR using the first features, the first context, and the required expertise of the PR reviewers, wherein the predetermined rules determine code quality;
determining, by a quality calculator engine of the PRSP, a first quality based on the first weighted average score for the predetermined rules;
after determining the first quality, making a first determination that the first quality is at a first quality level, wherein the first quality level is one of a plurality of quality levels;
after making the first determination:
making a second determination that an expert reviewer is available to review the first PR;
transmitting the first PR and first quality to the expert reviewer in response to the second determination, wherein the expert reviewer approves the first PR to be uploaded to a main repository; and
after the expert reviewer approves the first PR, uploading the first code in the first PR to the main repository via the PR orchestrator to be merged with the main code, wherein uploading is performed in a first order with the other PRs using the dependency relationship contained in the first context.

10. The non-transitory CRM of claim 9, further comprising:
receiving, at the PRSP engine, a second PR, wherein:
the second PR comprises a second code and is a second request by the developer to have the second code incorporated into the main code for the project, and
the second PR is stored on the PR orchestrator after being received from the developer workspace;
extracting second features from the second PR;
after extracting the second features from the second PR, identifying a second required expertise of the PR reviewers needed to review the second PR using the second features;
analyzing a second context of the second PR, wherein the second context is contained in the second features and determines any second dependency relationship the second PR has with the other PRs of the project;
in response to the second required expertise of the PR reviewers, assigning at least one assigned PR reviewer using the second features;
calculating, by the quality and scoring module of the PRSP engine comprising a scoring engine machine learning model, a second weighted average score for the predetermined rules of the second PR using the second features, the second context, and the second required expertise of the PR reviewers;
determining, by the quality calculator engine of the PRSP, a second quality based on the second weighted average score for the predetermined rules;
after determining the second quality, making a third determination that the second quality is at the first quality level of the plurality of quality levels;
after making the third determination:
making a fourth determination that the expert reviewer is not available to review the second PR;
transmitting the second PR and the second quality to the at least one assigned PR reviewer in response to the fourth determination, wherein the at least one assigned PR reviewer approves the second PR to be uploaded to the main repository; and
after the at least one assigned PR reviewer approves the second PR, uploading the second code in the second PR to the main repository via the PR orchestrator to be merged with the main code, wherein uploading is performed in a second order with the other PRs using the second dependency relationship contained in the second context.

11. The non-transitory CRM of claim 9, further comprising:
receiving, at the PRSP engine, a second PR, wherein:
the second PR comprises a second code and is a second request by the developer to have the second code incorporated into the main code for the project, and
the second PR is stored on the PR orchestrator after being received from the developer workspace, and extracting second features from the second PR;
after extracting the second features from the second PR, identifying a second required expertise of the PR reviewers needed to review the second PR using the second features;
analyzing a second context of the second PR, wherein the second context is contained in the second features and determines any second dependency relationship the second PR has with the other PRs of the project;
in response to the second required expertise of the PR reviewers, assigning at least one assigned PR reviewer using the second features;
calculating, by the quality and scoring module of the PRSP engine comprising a scoring engine machine learning model, a second weighted average score for the predetermined rules of the second PR using the second features, the second context, and the second required expertise of the PR reviewers;
determining, by the quality calculator engine of the PRSP, a second quality based on the second weighted average score for the predetermined rules;
after determining the second quality, making a third determination that the second quality is not at the first quality level of the plurality of quality levels;
after making the third determination:
making a fourth determination that the second quality is at a second quality level of the plurality of quality levels;
transmitting, in response to the fourth determination, the second PR to the assigned PR reviewer, wherein the at least one assigned PR reviewer approves sending the second PR to be sent back to the developer workspace for minor revisions; and
after the at least one assigned PR reviewer approves sending the second PR to the developer workspace, transmitting the second PR to the developer workspace for minor revisions.

12. The non-transitory CRM of claim 9, further comprising:
receiving, at the PRSP engine, a second PR, wherein:
the second PR comprises a second code and is a second request by the developer to have the second code incorporated into the main code for the project, and
the second PR is stored on the PR orchestrator after being received from the developer workspace;
extracting second features from the second PR;
after extracting the second features from the second PR, identifying a second required expertise of the PR reviewers needed to review the second PR using the second features;
analyzing a second context of the second PR, wherein the second context is contained in the second features and determines any second dependency relationship the second PR has with the other PRs of the project;
in response to the second required expertise of the PR reviewers, assigning at least one assigned PR reviewer using the second features;
calculating, by the quality and scoring module of the PRSP engine comprising a scoring engine machine learning model, a second weighted average score for the predetermined rules of the second PR using the second features, the second context, and the second required expertise of the PR reviewers;
determining, by the quality calculator engine of the PRSP, a second quality based on the second weighted average score for the predetermined rules;
after determining the second quality, making a third determination that the second quality is not at the first quality level of the plurality of quality levels;
after making the third determination:
making a fourth determination that the second quality is at a third quality level of the plurality of quality levels;
transmitting, in response to the fourth determination, the second PR to the assigned PR reviewer, wherein the at least one assigned PR reviewer approves sending the second PR to be sent back to the developer workspace for major revisions; and
after the at least one assigned PR reviewer approves sending the second PR to the developer workspace, transmitting the second PR to the developer workspace for major revisions.

13. The non-transitory CRM of claim 9, wherein extracting the first features from the first PR comprises:
extracting code changes, commit messages, the first context, and developer information; and
analyzing, by a code quality analyzer, the first PR using metrics comprising complexity, readability, and test coverage.

14. The non-transitory CRM of claim 9, wherein calculating the first weighted average score for the predetermined rules comprises:
calculating first scores for the predetermined rules as an output and using the first features, the predetermined rules, and the required expertise of the PR reviewers as inputs for the scoring engine machine learning model; and
aggregating, by a scoring aggregator, the first scores into the first weighted average score.

15. The non-transitory CRM of claim 14, wherein the predetermined rules comprise code style compliance, static code analysis, dynamic code analysis, code review approvals, commit message standards, deployment status, regression test, unit test, code coverage, and ticket severity.

16. The non-transitory CRM of claim 9, wherein the first PR is determined to be dependent on a second PR based on the first context, and after the first PR and the second PR are approved to be merged with the main code, the second PR is uploaded into the main repository before the first PR from the PR orchestrator.

17. A PR scoring and prioritization (PRSP) engine, comprising:
a processor;
storage comprising instructions, which when executed by the processor perform a method, the method comprising:
receiving, at the PRSP engine, a first PR, wherein:
the first PR comprises a first code and is a request by a developer to have the first code incorporated into a main code for a project, and
the first PR is stored on a PR orchestrator after being received from a developer workspace;
extracting first features from the first PR;
after extracting the first features from the PR, identifying a required expertise of PR reviewers needed to review the first PR using the first features;
analyzing a first context of the first PR, wherein the first context is contained in the first features and determines any dependency relationship the first PR has with other PRs of the project;
calculating, by a quality and scoring module of the PRSP engine comprising a scoring engine machine learning model, a first weighted average score for predetermined rules of the first PR using the first features, the first context, and the required expertise of the PR reviewers, wherein the predetermined rules determine code quality;
determining, by a quality calculator engine of the PRSP, a first quality based on the first weighted average score for the predetermined rules;
after determining the first quality, making a first determination that the first quality is at a first quality level, wherein the first quality level is one of a plurality of quality levels;
after making the first determination:
making a second determination that an expert reviewer is available to review the first PR;
transmitting the first PR and first quality to the expert reviewer in response to the second determination, wherein the expert reviewer approves the first PR to be uploaded to a main repository; and
after the expert reviewer approves the first PR, uploading the first code in the first PR to the main repository via the PR orchestrator to be merged with the main code, wherein uploading is performed in a first order with the other PRs using the dependency relationship contained in the first context.

18. The PRSP engine of claim 17, wherein the method further comprises:
receiving, at the PRSP engine, a second PR, wherein:
the second PR comprises a second code and is a second request by the developer to have the second code incorporated into the main code for the project, and
the second PR is stored on the PR orchestrator after being received from the developer workspace;
extracting second features from the second PR;
after extracting the second features from the second PR, identifying a second required expertise of the PR reviewers needed to review the second PR using the second features;
analyzing a second context of the second PR, wherein the second context is contained in the second features and determines any second dependency relationship the second PR has with the other PRs of the project;
in response to the second required expertise of the PR reviewers, assigning at least one assigned PR reviewer using the second features;
calculating, by the quality and scoring module of the PRSP engine comprising a scoring engine machine learning model, a second weighted average score for the predetermined rules of the second PR using the second features, the second context, and the second required expertise of the PR reviewers;
determining, by the quality calculator engine of the PRSP, a second quality based on the second weighted average score for the predetermined rules;
after determining the second quality, making a third determination that the second quality is at the first quality level of the plurality of quality levels;
after making the third determination:
making a fourth determination that the expert reviewer is not available to review the second PR;
transmitting the second PR and the second quality to the at least one assigned PR reviewer in response to the fourth determination, wherein the at least one assigned PR reviewer approves the second PR to be uploaded to the main repository; and
after the at least one assigned PR reviewer approves the second PR, uploading the second code in the second PR to the main repository via the PR orchestrator to be merged with the main code, wherein uploading is performed in a second order with the other PRs using the second dependency relationship contained in the second context.

19. The PRSP engine of claim 17, wherein the method further comprises:
receiving, at the PRSP engine, a second PR, wherein:
the second PR comprises a second code and is a second request by the developer to have the second code incorporated into the main code for the project, and
the second PR is stored on the PR orchestrator after being received from the developer workspace, and extracting second features from the second PR;
after extracting the second features from the second PR, identifying a second required expertise of the PR reviewers needed to review the second PR using the second features;
analyzing a second context of the second PR, wherein the second context is contained in the second features and determines any second dependency relationship the second PR has with the other PRs of the project;
in response to the second required expertise of the PR reviewers, assigning at least one assigned PR reviewer using the second features;
calculating, by the quality and scoring module of the PRSP engine comprising a scoring engine machine learning model, a second weighted average score for the predetermined rules of the second PR using the second features, the second context, and the second required expertise of the PR reviewers;
determining, by the quality calculator engine of the PRSP, a second quality based on the second weighted average score for the predetermined rules;
after determining the second quality, making a third determination that the second quality is not at the first quality level of the plurality of quality levels;
after making the third determination:
making a fourth determination that the second quality is at a second quality level of the plurality of quality levels;
transmitting, in response to the fourth determination, the second PR to the assigned PR reviewer, wherein the at least one assigned PR reviewer approves sending the second PR to be sent back to the developer workspace for minor revisions; and
after the at least one assigned PR reviewer approves sending the second PR to the developer workspace, transmitting the second PR to the developer workspace for minor revisions.

20. The PRSP engine of claim 17, wherein the method further comprises:
receiving, at the PRSP engine, a second PR, wherein:
the second PR comprises a second code and is a second request by the developer to have the second code incorporated into the main code for the project, and
the second PR is stored on the PR orchestrator after being received from the developer workspace;
extracting second features from the second PR;
after extracting the second features from the second PR, identifying a second required expertise of the PR reviewers needed to review the second PR using the second features;
analyzing a second context of the second PR, wherein the second context is contained in the second features and determines any second dependency relationship the second PR has with the other PRs of the project;
in response to the second required expertise of the PR reviewers, assigning at least one assigned PR reviewer using the second features;
calculating, by the quality and scoring module of the PRSP engine comprising a scoring engine machine learning model, a second weighted average score for the predetermined rules of the second PR using the second features, the second context, and the second required expertise of the PR reviewers;
determining, by the quality calculator engine of the PRSP, a second quality based on the second weighted average score for the predetermined rules;
after determining the second quality, making a third determination that the second quality is not at the first quality level of the plurality of quality levels;
after making the third determination:
making a fourth determination that the second quality is at a third quality level of the plurality of quality levels;
transmitting, in response to the fourth determination, the second PR to the assigned PR reviewer, wherein the at least one assigned PR reviewer approves sending the second PR to be sent back to the developer workspace for major revisions; and
after the at least one assigned PR reviewer approves sending the second PR to the developer workspace, transmitting the second PR to the developer workspace for major revisions.
